(19) United States
(12) Patent Application Publication
(10) Pub. No.: US 2007/0146105 A1
(43) Pub. Date: Jun. 28, 2007

(54) Complementary inductor structures

(76) Inventors: Xiang Yin Zeng, Pu Dong (CN); Jiangqi He, Gilbert, AZ (US); BaoShu Xu, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/320,942

(22) Filed: Dec. 28, 2005

(51) Int. Cl. H01F 1/00

(52) U.S. Cl. 335/209

(57) ABSTRACT

Complementary inductor structures. The inductor structure may include two or more sub-inductors that have positive coupling to provide a total inductance approximately equal to the sum of the inductance provided by the two or more sub-inductors. Radiation from the two or more sub-inductors may be in different phases to partially, or even totally, cancel and result in a reduced overall radiation, which may reduce electromagnetic interference and/or electromagnetic coupling.

### TECHNICAL FIELD

Embodiments of the invention relate to inductors that may be used in radio frequency (RF) circuitry. More particularly, embodiments of the invention relate to a complementary inductor structure that may be used in RF circuitry.

### BACKGROUND

Inductors are commonly used circuit elements in radio frequency (RF) devices that are typically constructed of coiled conductive material. FIG. 1a is a block diagram of a single inductor structure. Inductor 150 may be coupled with the remainder of a circuit (not illustrated in FIG. 1a) via two conductive leads 110, 120. FIG. 1b illustrates a physical layout of a prior art single inductor structure that may be used in a RF circuit. Inductor 150 consists of a single coil of conductive material having the physical characteristics necessary to provide the desired inductance. Physical design of such inductors is well known in the art.

The inductor of FIG. 1b may be coupled with other circuit elements (e.g., resistors, capacitors) to create many types of circuits including radio frequency (RF) circuits. One challenge for RF circuit design and packaging is meeting various electromagnetic emissions requirements. As current flows through an inductor radiation is generated including a magnetic field.

FIG. 1c illustrates a multi-turn wire inductor with illustrated example current flow and resulting magnetic field. As current flows in the direction indicated by arrow 180 magnetic field (\vec{B}) 190 may be generated. Reversing the direction of the current flow results in a reverse magnetic field. Generation of a magnetic field from current flow is well known in the art.

One potential disadvantage of the radiation generated by an inductor is potential electromagnetic interference and/or electromagnetic coupling with other devices. In order to limit electromagnetic interference and/or electromagnetic coupling, devices having inductive components typically include a shielding structure, which may increase the size, cost and/or complexity of the device that includes an inductor. In some situations, if the shielding structure is not well grounded, electromagnetic radiation may be increased.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1a is a block diagram of a single inductor structure.

FIG. 1b illustrates a physical layout of a prior art single inductor structure that may be used in a RF circuit.

FIG. 1c illustrates a multi-turn wire inductor with illustrated example current flow and resulting magnetic field.

FIG. 2a is a block diagram of a complementary inductor structure.

FIG. 2b illustrates an example physical layout of a complementary inductor structure that may be used in a RF circuit.

FIG. 2c illustrates one embodiment of two multi-turn wire inductors with illustrated example current flow and resulting magnetic fields.

FIG. 3 is a block diagram of one embodiment of an electronic system.

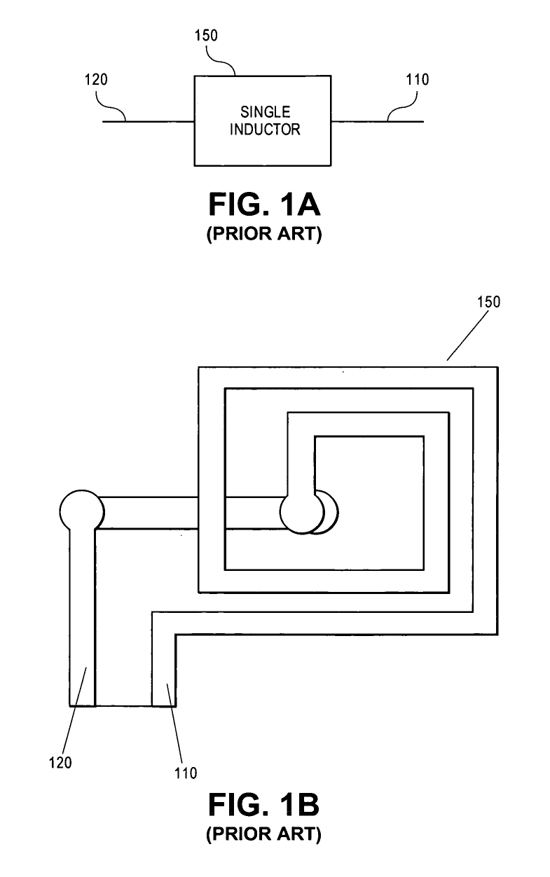

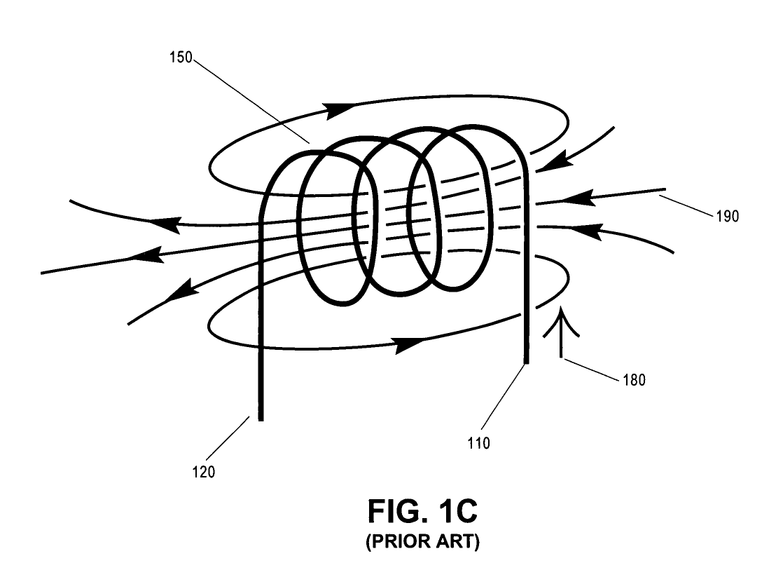

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

One challenge for production of electronic systems that include radiating components, for example, inductors, is compliance with governmental electromagnetic interference and/or electromagnetic coupling regulations. When current flows through an inductor, for example, radiation is generated. In general, the larger the inductance the greater the radiation for comparable current flow. The increased radiation may result in increased electromagnetic interference and/or electromagnetic coupling.

Described herein are embodiments of a complementary inductor structure in which electromagnetic radiation may be reduced as compared to traditional techniques. The inductor structures described herein may be implemented at the circuit board level, the package level or the integrated circuit level. In general, previous design strategies considered electromagnetic radiation management at the system level. That is, designs to counteract or shield electromagnetic radiation caused by system components, for example, inductors are determined after the functionality of the system has been designed.

In contrast to previous design strategies, the component design including, for example, inductors, may include component design and/or layout that may reduce or even eliminate electromagnetic radiation. In one embodiment, an inductor may be constructed of two or more sub-inductors. As described in greater detail below, the sub-inductors may be interconnected and positioned to provide the desired inductance while providing reduced (or no) electromagnetic radiation.

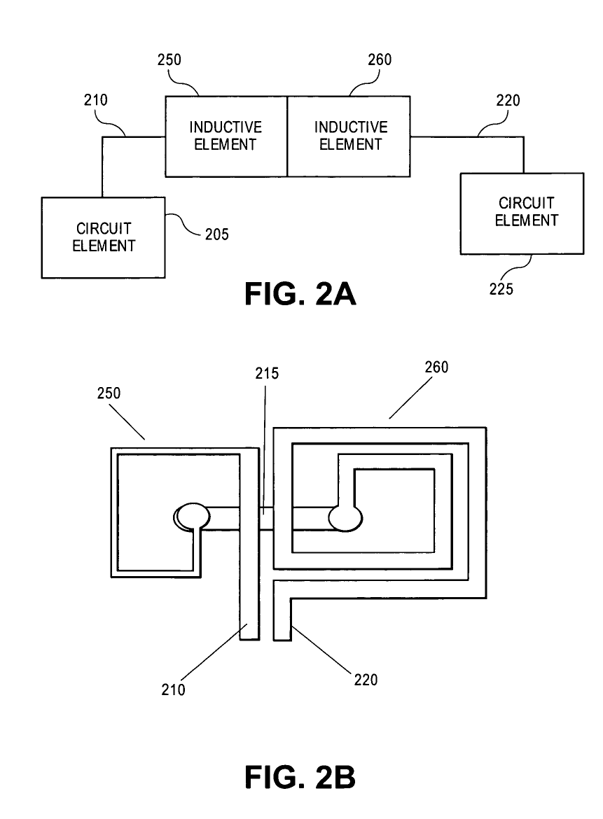

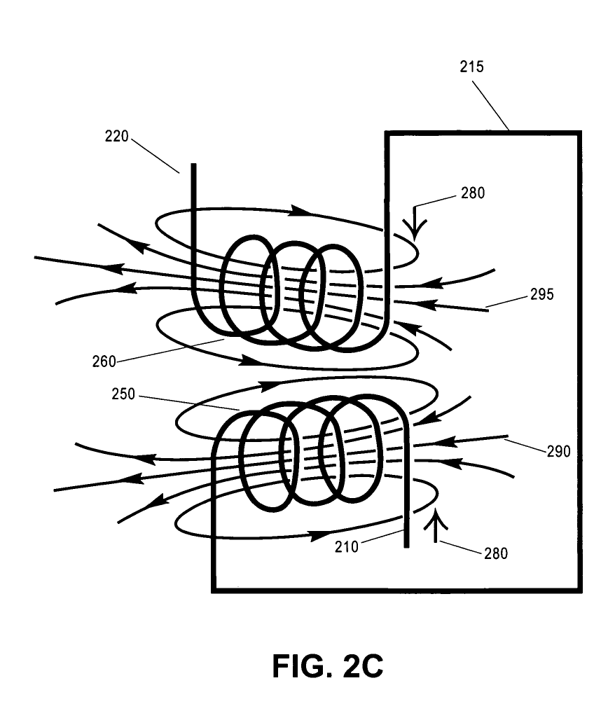

FIG. 2a is a block diagram of a complementary inductor structure. When two inductor structures are placed near one another, the resulting inductive coupling can be either positive or negative. With proper placement of inductive element 250 and inductive element 260 to provide positive coupling the inductance of inductive element 250 can be added to the inductance of inductive element 260.

Because radiation of a spiral inductor is equivalent to a magnetic dipole, when two inductors placed side by side have positive coupling, the resulting magnetic dipole is 180 degrees out of phase resulting in cancellation or reduction of the electromagnetic radiation. In one embodiment inductive element 250 and inductive element 260 may be coupled together as described herein and coupled with other circuit elements (e.g., 205, 225), for example, one or more resistors, capacitors, diodes, and/or other inductors via conductive leads 210 and 220.

FIG. 2b illustrates an example physical layout of a complementary inductor structure that may be used in a RF circuit. In one embodiment, the inductive elements are spiral shaped conductive elements (e.g., wire, metal trace). The direction of the spiral for one inductive element may be the opposite direction of the spiral of the complementary inductive element. This may result in a partial, or even complete, cancellation of radiation caused by the respective inductive elements with respect to far field radiation.

In one embodiment, inductive element 260 may be any type of inductive element that provides approximately half of the inductance to be provided by the combination of inductive elements 250 and 260. Inductive element 250 may be coupled with inductive element 250 by line 215 to provide the other half of the desired inductance. Further, inductive elements 250 and 260 may be positioned such that the magnetic dipole from inductive element 250 is 180 degrees out of phase with the magnetic dipole of inductive element 260, which may result in reduction or cancellation of the electromagnetic radiation caused by the combination of inductive elements 250 and 260.

FIG. 2c illustrates one embodiment of two multi-turn wire inductors with illustrated example current flow and resulting magnetic fields. As current flows in the direction indicated by arrow 280, magnetic field (\vec{B}) 290 may be generated in coil 250 while magnetic field 295 may be generated in coil 260. Coils 250 and 260 may be positioned such that magnetic field 290 and magnetic 295 partially, or completely, cancel each other out at distances (e.g., 3 m) from the circuit components where electromagnetic interference and/or electromagnetic coupling may be problematic.

An inductor constructed of two or more inductive elements may be utilized in any circuit that may require an inductor. For example, in a radio frequency (RF) circuit, the complementary inductor structure may be utilized to reduce or eliminate electromagnetic interference and/or electromagnetic coupling. The complementary inductor structure described herein may be manufactured as part of a device package, as part of an integrated circuit or on a printed circuit board.

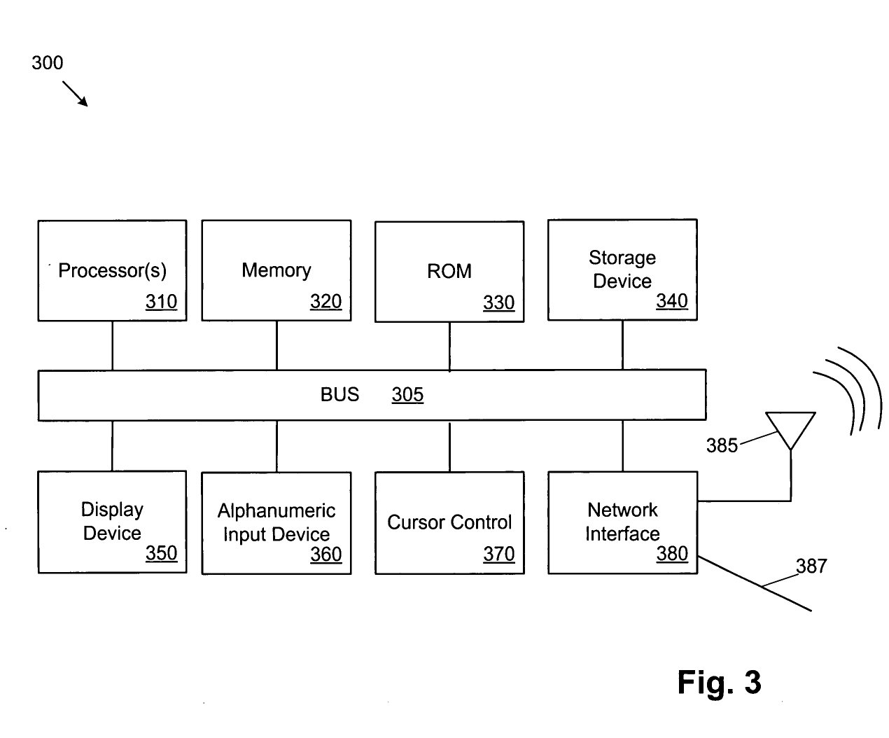

FIG. 3 is a block diagram of one embodiment of an electronic system. The electronic system illustrated in FIG. 3 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 300 may include bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as memory), coupled to bus 305 and may store information and instructions that may be executed by processor 310. Memory 320 may also be used to store temporary variables or other intermediate information during execution of instructions by processor 310.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 and or antenna 385 may include an inductor such as the inductor described above with respect to FIGS. 2a through 2c. Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network, for example, by conforming to IEEE 802.11b and/or IEEE 802.1g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.
What is claimed is:

1. An inductive structure comprising:
a first inductive element having a first inductance and a first magnetic field; and
a second inductive element coupled having a second inductance and a second magnetic field coupled with the first inductive element such that a combined inductance of the first inductive element and the second inductive element is approximately equal to the first inductance plus the second inductance, wherein the first magnetic field is out of phase with the second magnetic field.

2. The inductive structure of claim 1 wherein the far field radiation caused by the first magnetic field and the second magnetic field is approximately zero.

3. The inductive structure of claim 1 wherein the first inductive element comprises a generally spiral shape.

4. The inductive structure of claim 3 wherein the second inductive element comprises a generally spiral shape.

5. The inductive structure of claim 1 wherein the first inductive element and the second inductive element are manufactured on a printed circuit board.

6. The inductive structure of claim 1 wherein the first inductive element and the second inductive element are part of a device package.

7. The inductive structure of claim 1 wherein the first inductive element and the second inductive element are manufactured on an integrated circuit.

8. The inductive structure of claim 1 wherein the first magnetic field is approximately 180 degrees out of phase with the second magnetic field.

9. A system comprising:
an antenna;
a resistive structure coupled with the antenna;
an inductive structure coupled with the resistive structure having a first inductive element having a first inductance and a first magnetic dipole and a second inductive element coupled having a second inductance and a second magnetic dipole coupled with the first inductive element such that a combined inductance of the first inductive element and the second inductive element is approximately equal to the first inductance plus the second inductance, wherein the first magnetic dipole is out of phase with the second magnetic dipole.

10. The system of claim 9 wherein the far field radiation caused by the first magnetic field and the second magnetic field is approximately zero.

11. The system of claim 9 wherein the first inductive element comprises a generally spiral shape.

12. The system of claim 11 wherein the second inductive element comprises a generally spiral shape.

13. The system of claim 9 wherein the first inductive element and the second inductive element are manufactured on a printed circuit board.

14. The system of claim 9 wherein the first inductive element and the second inductive element are part of a device package.

15. The system of claim 9 wherein the first inductive element and the second inductive element are manufactured on an integrated circuit.

16. The system of claim 9 wherein the first magnetic dipole is approximately 180 degrees out of phase with the second magnetic dipole.

17. A circuit comprising:
an inductor having a first spiral having a first inductance and a first magnetic field and a second spiral having a second inductance and a second magnetic field coupled with the first spiral such that a combined inductance of the first spiral and the second spiral is approximately equal to the first inductance plus the second inductance, wherein the first magnetic field is out of phase with the second magnetic field; and
a resistor coupled with the inductor.

18. The circuit of claim 17 wherein the first spiral and the second spiral are manufactured on a printed circuit board.

19. The circuit of claim 17 wherein the first spiral and the second spiral are part of a device package.

20. The circuit of claim 17 wherein the first spiral and the second spiral are manufactured on an integrated circuit.
